(19) United States
(12) Patent Application Publication
(10) Pub. No.: US 2010/0080865 A1
(43) Pub. Date: Apr. 1, 2010

(54) Seal Structure and Seal Method

(75) Inventors: Wakana Kotani, Kariya-shi (JP); Masahiro Kimura, Chiryu-shi (JP); Eiichiro Iwase, Toyoake-shi (JP)

Correspondence Address: BUCHANAN, INGERSOLL & ROONEY PC, POST OFFICE BOX 1404, ALEXANDRIA, VA, 22313-1404, US

(73) Assignee: AISIN SEIKI KABUSHIKI KAISHA, Kariya-shi (JP)

(21) Appl. No.: 12/557,684

(22) Filed: Sep. 11, 2009

(30) Foreign Application Priority Data
Sep. 30, 2008 (JP) 2008-253086

(51) Int. Cl. B29C 33/00; F16J 15/02

(52) U.S. Cl. 425/406; 277/628

(57) ABSTRACT

A seal structure for sealing a first molding member and a second molding member that covers the first molding member, the seal structure includes a seal portion functioning as a boundary between the first molding member and the second molding member and sealing the first molding member and the second molding member by means of a thermal action, and a stress relax portion mounted around the seal portion and releasing a stress applied to the seal portion caused by the thermal action.

### CROSS REFERENCE TO RELATED APPLICATIONS

This application is based on and claims priority under 35 U. S. C. § 119 to Japanese Patent Application No. 2008-253086 filed on Sep. 30, 2008, the entire content of which is incorporated herein by reference.

### FIELD OF THE INVENTION

The present invention relates to a seal structure and a seal method.

### BACKGROUND

A molding material may be provided at an exterior of a sensor terminal, a wire harness, and the like for integrally connecting other members, waterproofing, and the like. A high melting point thermoplastic resin is generally used as the molding material. However, adhesion (sealing performance) of such thermoplastic with a harness coat and the like is weak. Then, a seal structure described in Japanese Patent Laid-open Print No. H08-111260A (hereinafter referred to as Reference 1) is proposed, for example. The seal structure disclosed in Reference 1 includes a seal member at an end portion of a wire harness. The seal member, which is made of thermoplastic resin, includes a sharply waved apex that melts to be fusion bonded to the mold resin to thereby obtain a sealing between the harness coat and the mold resin.

According to the seal structure disclosed in Reference 1, a seal potion (a joint potion) may break due to an expansion and a contraction of the thermoplastic resin because of the stress applied to the seal portion when the apex of the seal member is melting. For example, even when the seal member (a first molding member) and the molding material (a second molding member) which covers the seal member are made of the same material (for example, resin), the stress occurs by a difference in coefficients of thermal expansion of the first molding member and the second molding member caused by density or filler orientation difference depending on resin flow during the molding process. When a high stress occurs, the seal structure may brake because the high stress exceeds a bonding strength between the seal member and the molding material. Therefore, reliability of sealing is low.

The aforementioned stress especially increases with a resin having a high linear expansion, a product having a structure with a high linear expansion (a thick product), a resin in which coefficients of linear expansion are widely different between a flow direction and a vertical direction (for example, a resin including a glass), a resin with a high coefficient of solid contraction, products used in a large temperature fluctuation place, and the like.

A need thus exists for a seal structure and a seal method which is not susceptible to the drawback mentioned above.

### SUMMARY OF THE INVENTION

According to an aspect of the present invention, a seal structure for sealing a first molding member and a second molding member that covers the first molding member, the seal structure includes a seal portion functioning as a boundary between the first molding member and the second molding member and sealing the first molding member and the second molding member by means of a thermal action, and a stress relax portion mounted around the seal portion and releasing a stress applied to the seal portion caused by the thermal action.

### BRIEF DESCRIPTION OF THE DRAWINGS

The foregoing and additional features and characteristics of the present invention will become more apparent from the following detailed description considered with the reference to the accompanying drawings, wherein:

FIG. 1 illustrates a seal structure according to a first embodiment of the present invention;

FIG. 2 illustrates a seal member used in the seal structure as shown in FIG. 1;

FIG. 3 is a cross sectional view of the seal member of the seal structure according to FIG. 1, but showing the state after molding;

FIG. 4 is a comparative example of the seal structure;

FIG. 5A is a plan view of a seal member according to a second embodiment and FIG. 5B is a side view of the seal member according to the second embodiment;

FIGS. 6A and 6B are each schematic view of a seal structure in which the seal member as shown in FIGS. 5A and 5B is used;

FIG. 7A is a plan view of a seal member according to a third embodiment and FIG. 7B is a side view of the seal member according to the third embodiment;

FIGS. 8A and 8B are each schematic view of a seal structure in which the seal member as shown in FIGS. 7A and 7B is used;

FIG. 9 illustrates a seal member according to a fourth embodiment;

FIG. 10 illustrates a seal member according to a fifth embodiment;

FIG. 11 illustrates a seal structure according to a sixth embodiment;

FIG. 12 illustrates a seal structure according to a seventh embodiment; and

FIG. 13 illustrates a seal structure according to an eighth embodiment.

### DETAILED DESCRIPTION

Embodiments of a seal structure and a seal method according to the present invention will be explained below.

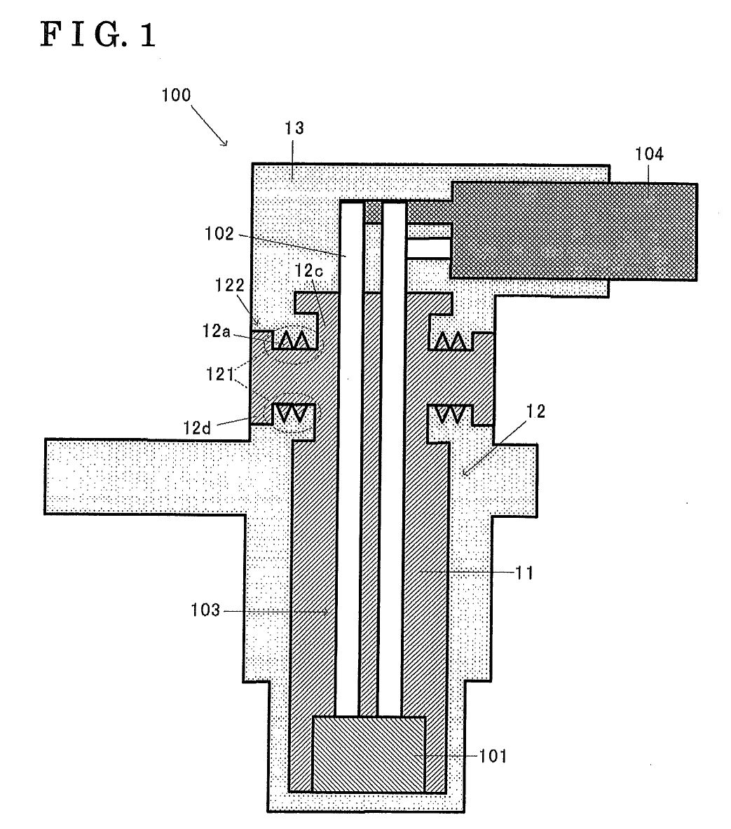

As shown in FIG. 1, the seal structure according to a first embodiment is used in a rotation sensor 100, for example. The rotation sensor 100 can be used in a breaking system for a vehicle (ABS), and the like.

The rotation sensor 100 includes a terminal sensor 103, a wire harness 104, a seal member 12 serving as a first molding member and a molding material 13 serving as a second molding member. The terminal sensor 103 includes a sensor chip 101 that detects a rotational speed of an output shaft of an engine mounted on a car, and a terminal 102. The wire harness 104 is electrically connected to the terminal 102. The seal member 12 includes a body portion 11. The molding material 13 covers the terminal sensor 103, the wire harness 104, and the seal member 12. The seal member 12 is mounted on the terminal sensor 103 at the body portion 11 and seals the terminal sensor 103 to the molding material 13.

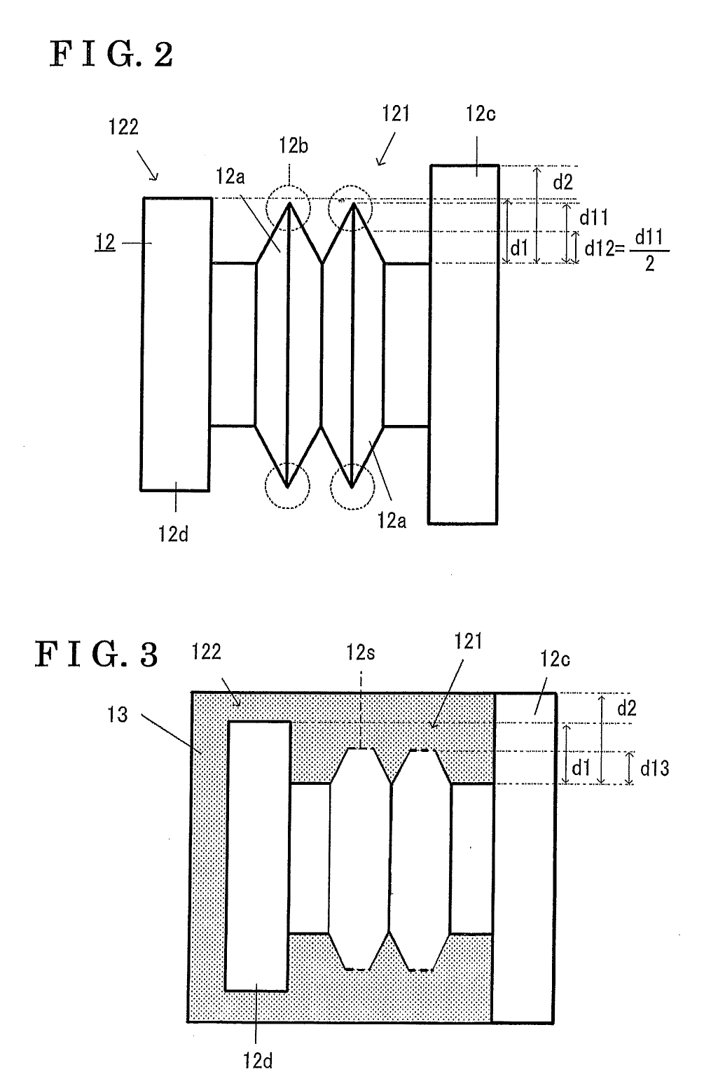

For example, the seal member 12 is made of thermoplastic resin. As shown in FIG. 2, the seal member 12 also includes a seal portion 121 and a stress relax portion 122.

The seal portion 121 includes a waved ring 12a formed into a triangular shape in cross section. The waved ring 12a includes an apex 12b (melting portion) on the top portion thereof. As shown in FIG. 3, the apex 12b melts and becomes a surface, specifically, a sealed surface 12s, so as to fuse to the molding material 13.

The stress relax portion 122 is provided with a first wall 12c and a second wall 12d around the seal portion 121. The first wall 12c and the second wall 12d are located at both sides of the seal portion 121 in such a manner that the seal portion 121 is provided between the first wall 12c and the second wall 12d. The first wall 12c and the second wall 12d are each formed with a columnar ring and each have a rectangular cross section. As shown in FIG. 3, heights d1 and d2 of the first wall 12c and the second wall 12d are specified to be equal to or higher than a height d13. The height d13 indicates a height after each of the apexes 12b of the waved ring 12a melts after the molding material 13 is applied. As shown in FIG. 2, the heights d1 and d2 of the first and second walls 12c and 12d are specified to be higher than a height d12. The height d12 is a half of a height d11 that indicates the height of the waved ring 12a. The first wall 12c and the second wall 12d protrude perpendicular to the sealed surface 12s (see FIG. 3). During the molding process, these rectangular columns (rectangular parallelepiped) of the first wall 12c and the second wall 12d release the stress applied to the seal portion 121 in a direction parallel to the sealed surface 12s.

When manufacturing the seal structure according to the embodiment, the body portion 11 of the seal member 12 is mounted on the terminal sensor 103 beforehand in a manner as illustrated in FIG. 1. Thereafter, the molding material 13 in the molten condition is injection molded as shown in FIG. 3.

During the injection molding process, the seal portion 121 is heated by mold heating. The apex 12b of the waved ring 12a melts when a melting point thereof is exceeded. Thereafter, the entire seal portion 121 is cooled and solidified. At this time, a molten resin of the waved ring 12a, and the molding material 13 are fusion bonded. The waved ring 12a and the solidified molding material 13 are welded to each other.

A coefficient of thermal expansion of the waved ring 12a and a coefficient of thermal expansion of the solidified molding material 13 may be different from each other because of a difference in coefficient of linear expansion and a resin flow in the molding process, and the like. In this case, contraction of the seal member 12 and contraction of the solidified molding material 13 are different from each other in association with a temperature change during the cooling and thus the stress is applied from the molding material 13 to the seal portion 121.

In addition, in a case where the molding material 13 covers the seal member 12 according to the rotation sensor 100, a contraction region of the molding material 13 is larger than that of the seal member 12, even when the coefficient of thermal expansion of the waved ring 12a and the coefficient of thermal expansion of the solidified molding material 13 are the same. Therefore, contraction of the molding member 13 is larger than contraction of the seal portion 121. Consequently, the stress is applied from the molding material 13 to the seal portion 121.

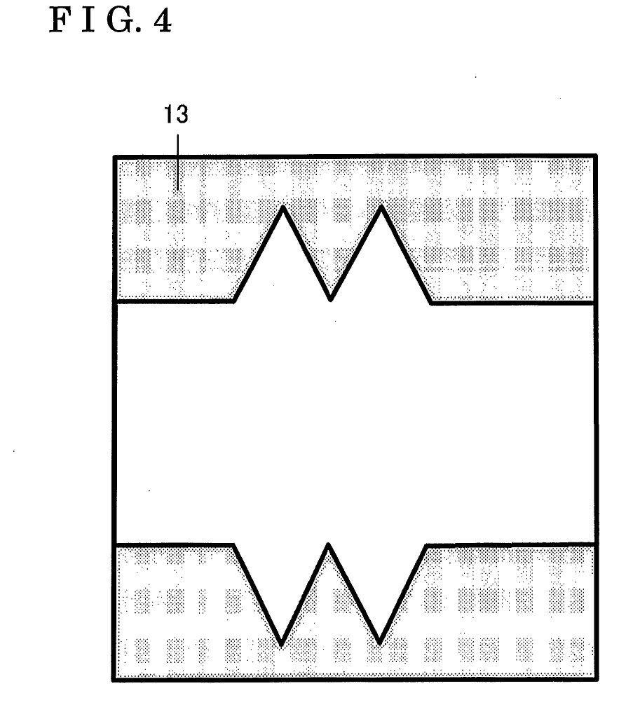

However, the seal structure according to the embodiment includes the stress relax portion 122 around the seal portion 121. Thus, the stress applied to the seal portion 121 is relieved compared to a seal structure not provided with the stress relax portion as illustrated in FIG. 4. Specifically, the waved ring 12a of the seal portion 121 disposed between the first wall 12c and the second wall 12d receives the stress from the molding material 13 which is provided at both inner and outer sides of the first wall 12c and the second wall 12d resulting from the contraction of the molding material 13 in association with solidification thereof. However, the seal structure according to the embodiment is provided with the first wall 12c and the second wall 12d as the stress relax portion 122 around the seal portion 121. Thus, the stress resulting from the contraction of the molding material 13 provided at the outer side of the first and second walls 12c and 12d is blocked thereby. The further contraction stress applied from the molding material 13 to the seal portion 121 is prevented accordingly. Consequently, the waved ring 12a basically receives the stress by the contraction of the molding material 13 provided only at a portion between the first and second walls 12c and 12d (i.e., at the inner side of the first and second walls 12c and 12d). Thus the contraction stress applied from the molding material 13 to the waved ring 12a is released.

The stress relax portion 122 may brake due to the stress received from the molding material 13 depending on the strength level (durability). In this case, according to the embodiment, the stress relax portion 122 is prevented from breaking by the stress because the stress relax portion 122 is formed by a wall having a rectangular columnar shape in a cross section to thereby achieve a sufficient strength.

The linear expansion of the molding material 13 provided between the first wall 12c and the second wall 12d is substantially the same as the linear expansion of the seal member 12. Therefore, the contraction of the molding material 13 is released and accordingly the stress applied to the seal member 12 is released.

The similar stress relief operation may occur when the seal structure is operating. However, because the stress relax portion 122 is provided, an internal stress that has remained in the seal member 12 and the molding material 13 after the molding, a stress caused by an expansion and a contraction of the seal member 12 and the molding material 13 in association with the temperature change during the operation of the seal structure or in association with water absorption and drying of the seal member 12 and the molding material 13, and the like are released.

Accordingly, the seal structure of the present embodiment achieves a highly reliable sealing function by releasing a stress applied to the seal portion 121.

As explained above, according to the seal structure and the seal method of the embodiment, the stress relax portion 122 is provided around the seal portion 121 to release the stress applied to the seal portion 121. Thus, the stress applied to the seal portion 121 is released and the more reliable seal structure is obtained.

The stress relax portion 122 is constituted by the first wall 12c and the second wall 12d which are a part of the seal member 12. Thus, the stress relax portion 122 is easily structured. Further, because the first wall 12c and the second wall 12d are simply formed, a structure of a mold for forming the seal member 12 is simplified.

Further, the first wall 12c and the second wall 12d are located to face each other in such a manner that the seal portion 121 is provided between the first wall 12c and the second wall 12d. Thus, the first wall 12c and the second wall 12d efficiently release the stress in expansion and contraction direction.

Because the first wall 12c and the second wall 12d each have a rectangular shape in a cross section, the first wall 12c and the second wall 12d securely release the stress.

The seal portion 121 includes the waved apex 12b that melts to seal the seal member 12 and the molding material 13 when heated. According to the aforementioned structure, an easy and accurate sealing is achieved by mold heating (the seal member 12 may be separately heated), and the like.

This present embodiment is not limited to have the aforementioned structure and is usable in various modifications and applications. In the following, second to eighth embodiment will be explained.

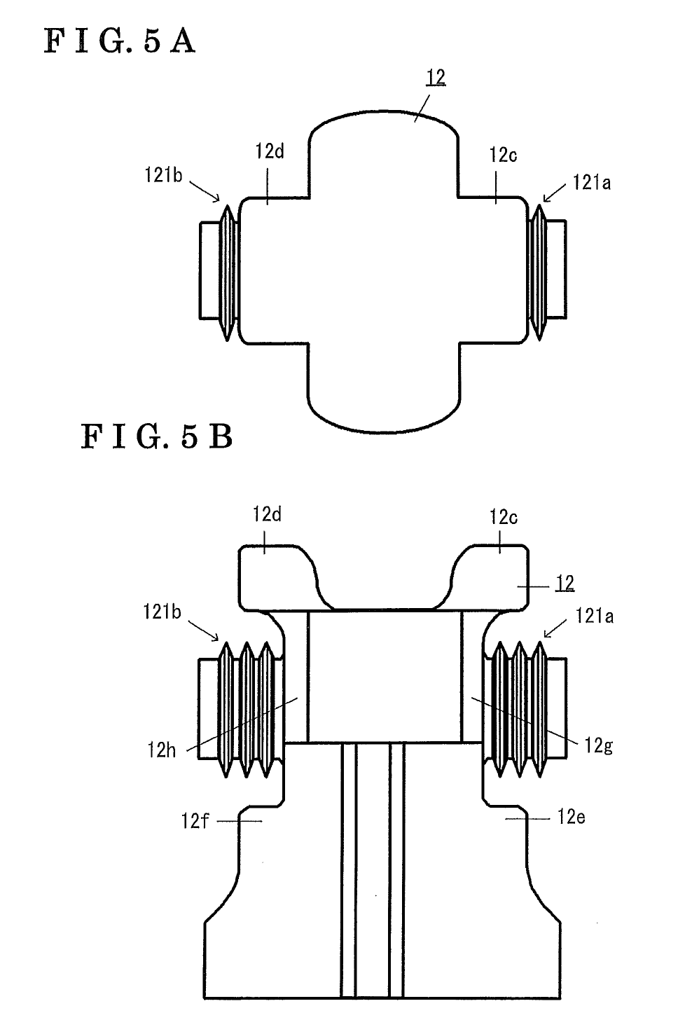

For example, according to the aforementioned first embodiment, the seal member 12 and the molding material 13 are linearly arranged and the molding material 13 covers the entire seal member 12. Alternatively, the seal member 12 and the molding material 13 may be formed in a manner illustrated in FIGS. 5A and 5B according to the second embodiment.

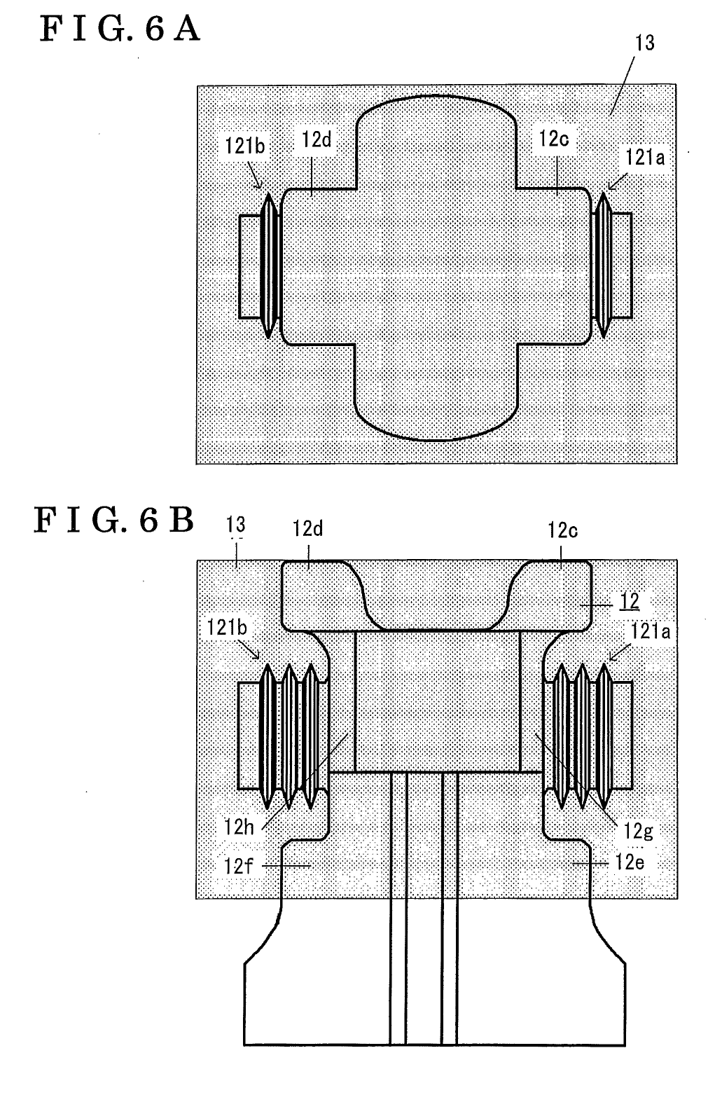

In FIGS. 5A and 5B, seal portions 121a and 121b are provided at both sides of the seal member 12. The seal member 12 is molded by the molding material 13 as shown in FIGS. 6A and 6B, for example. Walls 12c, 12e and a base portion 12g function as the stress relax portion of the seal portion 121a. The walls 12c and 12e are provided at upper and lower sides the seal portion 121a so as to extend substantially in parallel with the seal portion 121a. In addition, walls 12d, 12f and a base portion 12h function as the stress relax portion of the seal portion 121b. The walls 12d and 12f are provided at upper and lower sides of the seal portion 121b so as to extend substantially in parallel with the seal portion 121b.

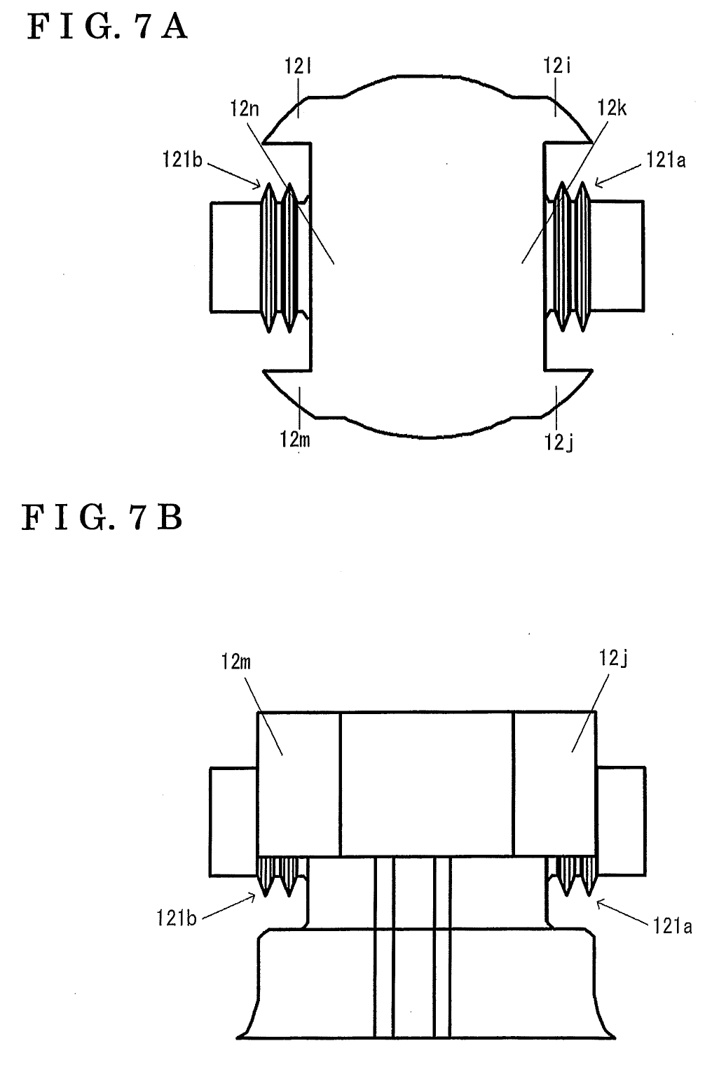

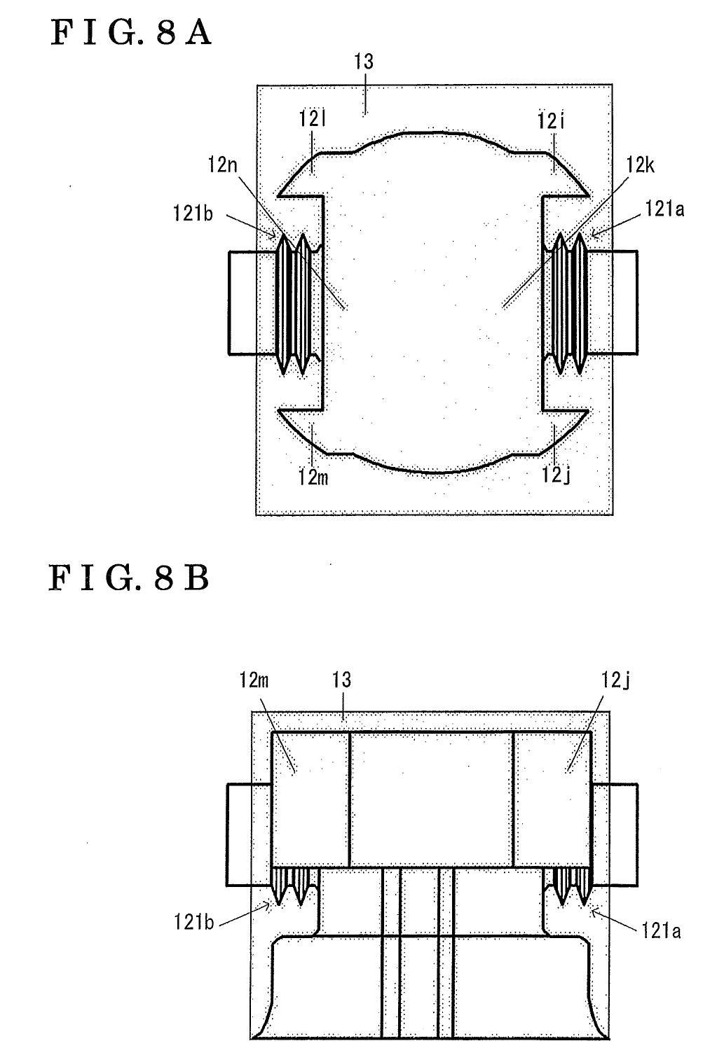

In addition, the seal member 12 may be formed in a manner illustrated in a plan view of FIG. 7A and a side view of FIG. 7B, and can be molded by the molding material 13 as shown in FIGS. 8A and 8B according to the third embodiment. Walls 12i, 12j, 12l, and 12m each formed into a column shape extend outwardly. Specifically, the walls 12i, 12j, 12l, and 12m protrude in parallel to the sealed surface formed between the seal member 12 and the molding material 13. In addition, the seal portion 121a is provided between the walls 12i and 12j and the seal portion 121b is provided between the walls 12l and 12m. In this case, the wall 12i, the wall 12j and a base portion 12k provided at upper and lower sides of the seal portion 121a serve as the stress relax portion of the seal portion 121a. On the other hand, the wall 12l, the wall 12m and a base portion 12n provided at upper and lower sides of the seal portion 121b serve the stress relax portion of the seal portion 121b.

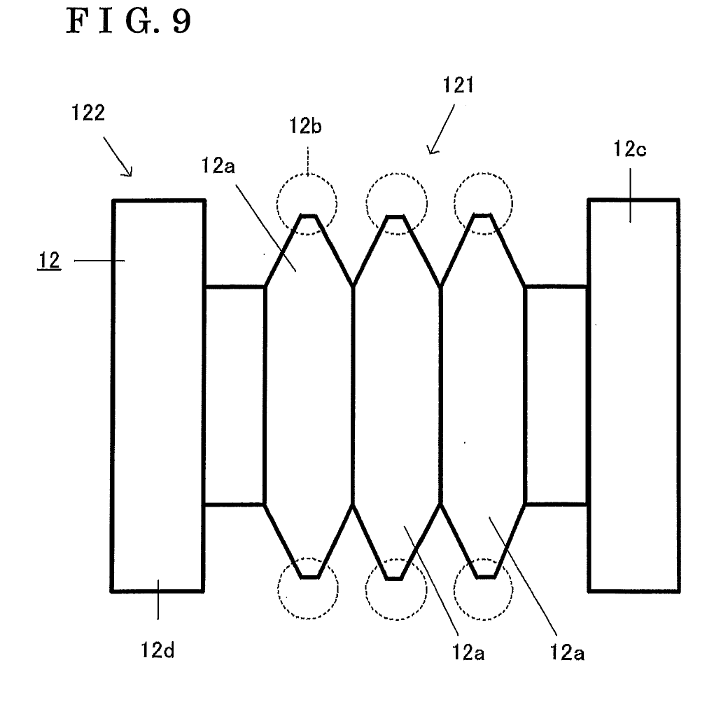

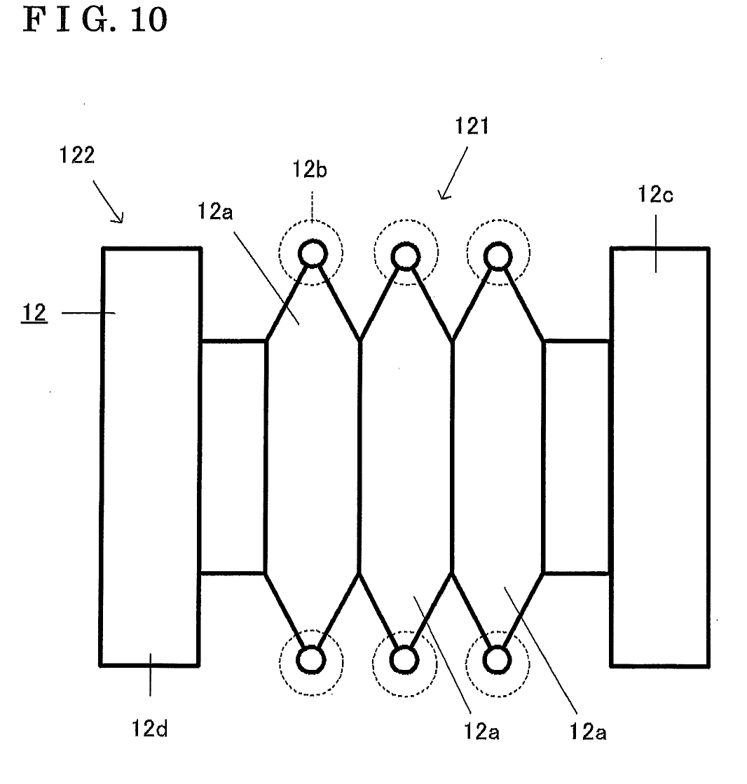

A shape of the apex 12b of the waved ring 12a (melting portion) may be changed in various manners. As illustrated in FIG. 9, the apex 12b of the waved ring 12a may be formed into a trapezoid shape according to the fourth embodiment. In addition, as illustrated in FIG. 10, the apex 12b of the waved ring 12a may be provided with a bulge portion (for example, a ring) according to the fifth embodiment. Consequently, a contact area of the seal portion 121 with the molding material 13 is extended and absorption of the mold heating is simplified. As a result, a melting degree is increased and a connection between the seal portion 121 and the molding material 13 is stronger.

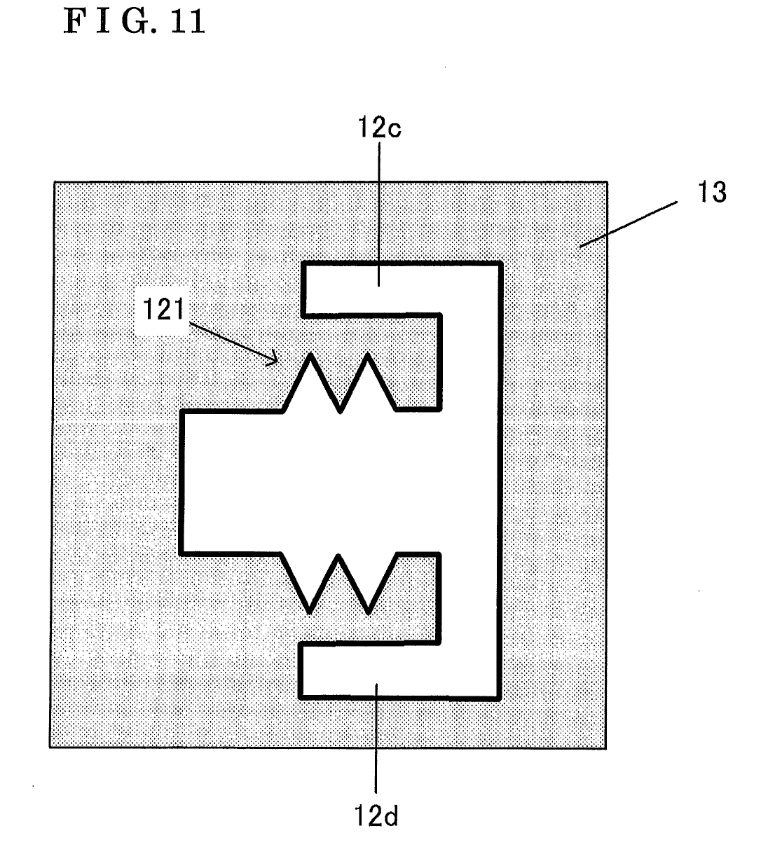

Further, as shown in FIG. 11, the first wall 12c and the second wall 12d in parallel to the sealed surface may be provided to face the sealed surface according to the sixth embodiment. Then, the seal portion 121 may be sandwiched from top to bottom (in a perpendicular direction to the sealed surface) by the first wall 12c and the second wall 12d to thereby release the stress applied from the perpendicular direction to the sealed surface. In addition, the first wall 12c and the second wall 12d may be each formed into a cylindrical shape.

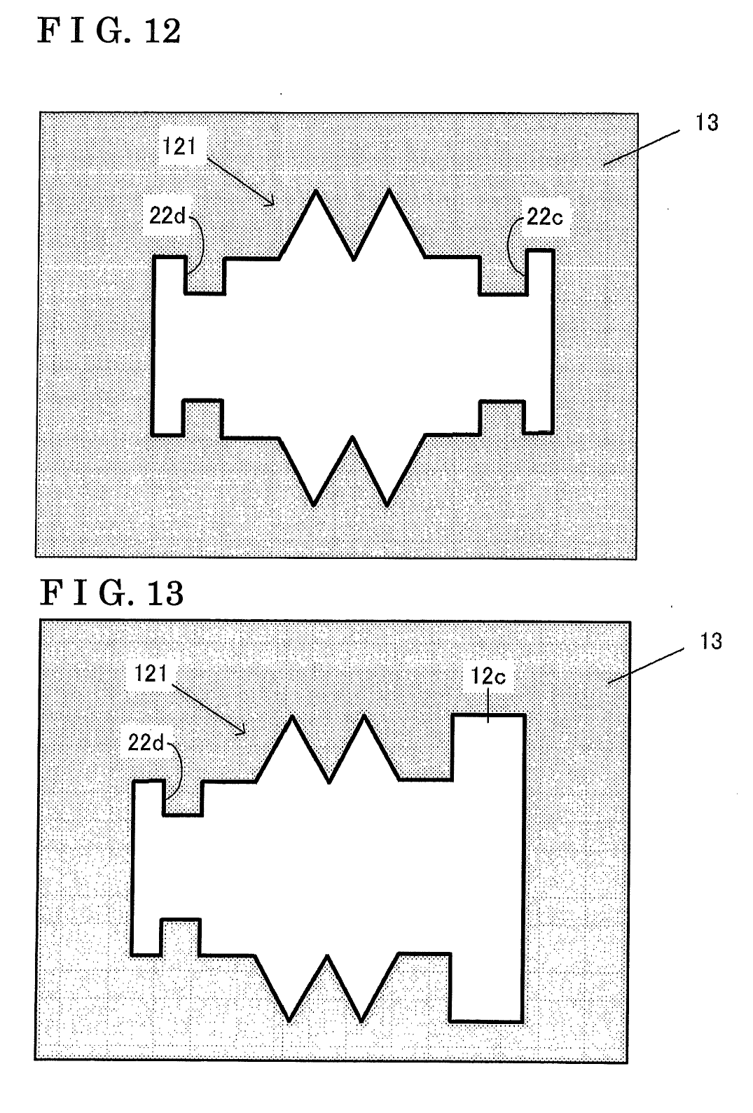

According to the aforementioned embodiments, the walls serve as the stress relax portion. Alternatively, as shown in FIG. 12, the stress relax portion may be substituted for a groove 22c and a groove 22d each formed by a columnar ring groove having a rectangular cross section according to the seventh embodiment.

In addition, a wall and a groove may be combined for the stress relax portion. For example, as shown in FIG. 13, a wall (the wall 12c formed by a columnar ring) and a groove (the groove 22d formed by a columnar ring groove) are disposed to face each other according to the eighth embodiment.

The wall and the groove are not limited to be the rectangular column shapes and may be formed into other shapes. For example, the wall and the groove may be each formed in a cylindrical shape. The shape of the stress relax portion may be formed more complex manner by using the stress analysis, and the like.

According to the aforementioned embodiments, the first and second walls, the first and second grooves and a combination thereof are explained. However, the number of grooves or walls serving as the stress relax portion is arbitrary. For example, the number of grooves or walls may be one, or equal to or more than three. Two or three pairs of walls or grooves, or a combination thereof may be provided so as to block the stress applied to the seal portion 121 from four or six directions.

In the aforementioned embodiments, the first molding member is the terminal sensor 103 on which the seal member 12 is mounted, and the second molding member that covers the first molding member is the molding material 13. Then, the terminal sensor 103 and the molding material 13 are sealed to each other. In this case, the embodiment is not limited to have the aforementioned structure and is applicable to seal another first molding member and another second molding member in a similar manner. For example, the embodiment is applicable to seal the wire harness 104 instead of the terminal sensor 103.

An arbitrary material may be used in the seal portion 121. For example, according to the aforementioned embodiments, the seal portion 121 is used for sealing the seal member 12 and the molding material 13 by the mold heating. Alternatively, by changing a material, and the like of the seal portion, the seal portion may be used for sealing the seal member 12 and the molding material 13 by cooling.

According to the aforementioned embodiments, the stress applied to the seal portion 121 is released to thereby achieve more reliable seal structure.

The stress relax portion 122 is at least one wall formed as a part of the seal member 12.

The at least one wall includes a first wall 12c and a second wall 12d located to face each other and between which the seal portion 121 is provided.

The at least one wall includes a rectangular cross-section.

The seal portion 121 includes a waved ring 12a (melting portion), and the seal member 12 and the molding material 3 are sealed by means of a fusion of the waved ring 12a (melting portion).

The stress relax portion 122 is at least one groove formed as a part of the seal member 12.

The at least one groove includes a first groove 22c and a second groove 22d located to face each other and between which the seal portion 121 is provided.

The thermal action is a heating process.

The thermal action is a cooling process.

The principles, preferred embodiment and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

1. A seal structure for sealing a first molding member and a second molding member that covers the first molding member, the seal structure comprising:
a seal portion functioning as a boundary between the first molding member and the second molding member and sealing the first molding member and the second molding member by means of a thermal action; and
a stress relax portion mounted around the seal portion and releasing a stress applied to the seal portion caused by the thermal action.

2. The seal structure according to claim 1, wherein the stress relax portion is at least one wall formed as a part of the first molding member.

3. The seal structure according to claim 2, wherein the at least one wall includes first and second walls located to face each other and between which the seal portion is provided.

4. The seal structure according to claim 2, wherein the at least one wall includes a rectangular cross-section.

5. The seal structure according to claim 1, wherein the seal portion includes a melting portion, and the first molding member and the second molding member are sealed by means of a fusion of the melting portion.

6. The seal structure according to claim 1, wherein the stress relax portion is at least one groove formed as a part of the first molding member.

7. The seal structure according to claim 6, wherein the at least one groove includes first and second grooves located to face each other and between which the seal portion is provided.

8. The seal structure according to claim 1, wherein the thermal action is a heating process.

9. The seal structure according to claim 1, wherein the thermal action is a cooling process.

10. A sealed assembly comprising:
cooperating first and second members between which a boundary is formed;
a sealing portion provided in the boundary to effect a seal between the first and second members upon receipt of a thermal action; and
a stress relax portion mounted around the seal portion and releasing a stress applied to the seal portion caused by the thermal action.

11. The sealed assembly according to claim 10, wherein the stress relax portion is at least one wall formed as a part of the first molding member.

12. The sealed assembly according to claim 11, wherein the at least one wall includes first and second walls located to face each other and between which the seal portion is provided.

13. The sealed assembly according to claim 11, wherein the at least one wall includes a rectangular cross-section.

14. The sealed assembly according to claim 10, wherein the seal portion includes a melting portion, and the first molding member and the second molding member are sealed by means of a fusion of the melting portion.

15. The sealed assembly according to claim 10, wherein the stress relax portion is at least one groove formed as a part of the first molding member.

16. The sealed assembly according to claim 15, wherein the at least one groove includes first and second grooves located to face each other and between which the seal portion is provided.

17. The sealed assembly according to claim 10, wherein the thermal action is a heating process.

18. The sealed assembly according to claim 10, wherein the thermal action is a cooling process.
